(19) United States
(12) Patent Application Publication
(10) Pub. No.: US 2007/0046889 A1
(43) Pub. Date: Mar. 1, 2007

(54) Eyewear with weighted flexible temples

(76) Inventors: Kenneth C. Miller, Aptos, CA (US); Michael Maurice Fjelstad, Scotts Valley, CA (US); Joseph C. Fjelstad, Maple Valley, WA (US)

Correspondence Address: Walt Froloff, 273D Searidge Rd, Aptos, CA, 95003, US

(21) Appl. No.: 11/508,451

(22) Filed: Aug. 23, 2006

Related U.S. Application Data
(60) Provisional application No. 60/711,141, filed on Aug. 24, 2005.

(51) Int. Cl. G02C 11/08

(52) U.S. Cl. 351/62

(57) ABSTRACT

An eyewear assembly having flexible temple elements with counterweights is disclosed. The counterweights and flexible temples can serve several other purposes aside from the disclosed role of supporting eyewear on a wearer's face. Those purposes include ornamental elegance in design and facilitating a natural adjustability around unique personal features for position and comfort. The flexible temple elements provide mechanisms for transmitting electrical, mechanical and photonic power and or signals to the eyewear while the counterweights provide the source for said transmissions from a more convenient location.

### CROSS-REFERENCES TO RELATED APPLICATIONS

This application is a Non-Provisional based on Provisional Patent Application No. U.S. 60/711,141 filed on Aug. 24, 2005.

### TECHNICAL FIELD

The present invention relates to the field of eyewear and more specifically to adjustable and flexible temples used with eyeglasses.

### BACKGROUND OF THE INVENTION

Eyewear (e.g., eyeglasses) are constructed in a wide range of styles and structures employing various design elements to achieve a desired blend of fashion and practical elements that make the eyewear suitable for use. One of the most vulnerable elements of common eyewear is the temple element, generally hinged to the frame or attached to the lens of the eyeglasses themselves. The temple help to support the eyeglasses to the user's face, creating an effective triangular support frame comprised of the bridge of the nose and the upper saddle of each of the user's ears. Thus traditionally, temples have been made of stiff materials such as metals or plastics that can be shaped to the comfort of the individual. The ability to shape and form the temples is important because it allows the temples to be adjusted and shaped to serve individual anatomical features. By way of example, one ear of an individual may be slightly higher or lower than the other so some adjustment is commonly needed to assure user comfort and alignment.

Temples are thus extremely important for eyewear. Moreover, they are also one of the most vulnerable elements of a set of eyeglasses. Temples are prone to breakage at the hinge due to inadvertent bending of the temple element beyond the mechanical strength limits of the hinge assembly. Thus, it is desirable to make temple hinges more resistant to breakage.

A number of inventors have disclosed methods of protecting the hinge by making the temples more flexible. An example can be found with eyeglasses having temples made of springy wire, such as NiTi-NOL, as described by Zider, et al. in U.S. Pat. No. 4,772,112. Others show methods for elimination of both hinges and the temples by attaching the frame to body piercing studs such as described by Rose in U.S. Pat. No. 6,557,994.

A number of inventions over the years describe hinge-less eyeglass frame constructions, for example, Anderson in U.S. Pat. No. 836,796 shows a flexible temple with a loop which attaches to the ear. Both Medina in U.S. Pat. No. 4,723,844 and Reese in U.S. Pat. No. 4,202,609, show the use of a doubled filament attached to ear loops to obviate the hinge while providing improved peripheral vision. In a similar vein, Hermsen in U.S. Pat. No. 6,736,504 shows a continuous loop of flexible material attached to the frames to allow the continuous flexible material to double as a necklace like holder of the eyeglasses when removed from the user's eyes. One disadvantage of this design is that it presents a possible risk of injury if the material does not easily break. Breslin appears to overcome this limitation in U.S. Design Pat. D471,580 using what appears to be a Velcro®-like fastener. However, this design applies pressure to the back of the head, and can become entangled with the hair.

Conner in U.S. Pat. No. 6,719,425 shows temple elements attached directly to the lens without benefit of hinge. Markovitz, et al., in U.S. Pat. No. 5,302,977 show an elastic band disposed to loop around the ears and tension the eyeglasses to the face.

Eyewear retainer structures attached to temples and frames by means of elastic bands with various clasping mechanisms have also been described. One representative example is that described by Fuller in U.S. Pat. No. 4,133,604.

While these inventions address and remedy many challenges related to eyewear temple design by revealing improvements which address issues associated with eyeglass manufacturer and use, there remains room for improvement. Disclosed herein is an improved flexible temple technology for eyewear.

### SUMMARY

A flexible temple assembly for eyewear is disclosed, comprising one end of at least one flexible material element coupled to the eyewear; at least one counterweight, coupled to the temple flexible material elements distal end, disposed to maintain tension on the flexible material element; whereby the flexible material element provides sufficient force to stably maintain the eyewear on wearer's face.

The flexible temple material can be clear monofilament polymer with or without cladding capable of photonic transmission. The flexible temple material can also be of chain, cloth, woven string, flexible fiber, plastic, composite, wire, optical fiber, electrical conductor, cable, multi-clad cable, coaxial cable, rottable in longitudinal axis cable insert, metal, and tubing.

### BRIEF DESCRIPTION OF THE DRAWINGS

The present invention may be more readily understood from a consideration of the following representative drawings wherein:

FIG. 1 is a frontal view of an eyewear assembly comprised of lenses and a nose bridge element.

FIG. 2A-2C are side view embodiments of the lens assembly of FIG. 1 having flexible temples with enlargements to show assembly detail of the temple attachment to the eyewear and distal temple counter weights.

FIG. 3 is a side view of an embodiment having a substantially straight external housing over a portion of the length of the flexible temple and adjustable temple weights.

FIG. 4 is a side view of an embodiment having a substantially straight external housing over a portion of the length of a flexible temple comprised of chain with distal end weights.

FIG. 5 is a side view of a lens of an embodiment having a curved external housing over a portion of the length of the flexible temple disposed to rest on the saddle of the user's ear including temple weights.

FIG. 6 is a perspective view of an eye ware embodiment having flexible temples with temple weights.

FIG. 7 is a user's view of an eyewear assembly embodiment with extended length flexible temples with position adjustable temple weights and having a clasping structure for joining the distal ends of the flexible temples.

FIG. 8 is a user's view of an eyewear assembly embodiment with extended length flexible temples wherein the temple weights serve also as the clasping mechanism.

FIG. 9 is a user's view of an eyewear assembly embodiment having a continuous flexible temple with a single sliding temple weight.

FIG. 10 is a user's view of an eyewear assembly embodiment having a single sliding counterweight on a second element tethered to the continuous flexible temple.

### DETAILED DESCRIPTION

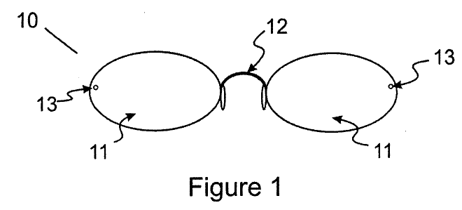

Referring to the drawings, shown in FIG. 1 are eyeglasses 10 disposed for assembly with flexible temples comprising lenses 11 and a central nose bridge 12 for joining the lenses. While the lenses are shown as ovals and the bridge is shown without other support for the lenses, other lens shapes and bridge configurations are possible, including the use of eyeglass frames with an integral bridge feature. In the figure each lens has a hole 13 in it to accept a flexible temple element. While in the figure, holes are shown as passing through the lens, the use of slots in the side of the lens or extensions (e.g., tabs) at the edges of the lens or rings through the lens itself could be used in alternative embodiments for securing the flexible temples into a defined location. Moreover, while the figure depicts rimless eyeglasses, alternative embodiments having more traditional frames may be constructed using methods and features described herein. The hole (or other flexible temple attachment feature) is preferably placed approximately along a horizontal centerline or relative to the lenses (i.e., left to right from the user's perspective) to ameliorate any tendency for the lens assembly from tipping or rotating either up or down on the wearer's face when in use.

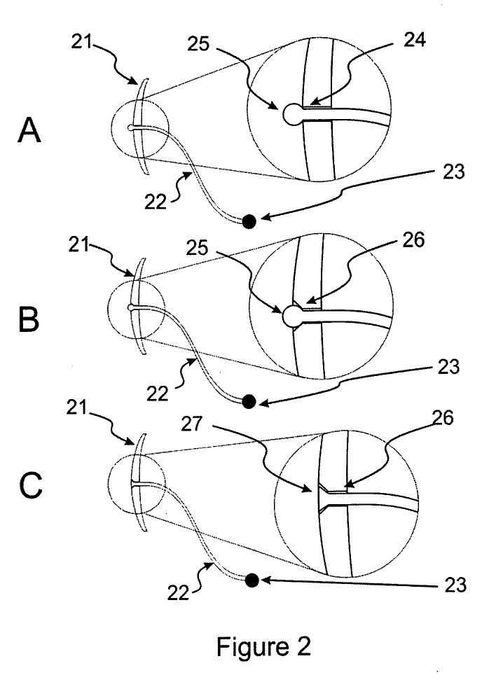

FIG. 2A-2C show prospective methods for securing a flexible temple with temple weight through the holes in the lenses and prevent the flexible temple from pulling through the holes. In FIG. 2A the lens 21 has a flexible temple element 22 pulled through a hole in the lens 24 (shown in detail in enlarged area). The flexible temple can be comprised of many different materials including: clear or opaque monofilament fibers, woven string, metal chain, woven cloth, low modulus flexible wire or any other suitably flexible material. In addition, it is possible that for certain constructions and embodiments of eyewear, the flexible temple could serve alternative uses including conduction of electricity or electronic signals and optical fibers could be used as the flexible temples for the transmission of light, images or information.

At the end of the flexible temple distal from the lens, the temple weight element 23, which serves as a counterweight, is attached to hold the flexible temple taut and secure the flexible temple over the saddle of the user's ear. The temple weight 23 can be of any suitably heavy material and size to secure the eye ware to the face of the user. Materials suitable for the temple weight include well known dense metals such as gold, silver, tin, lead etc. However, less dense metals and various organic and inorganic materials such as wood, glass and ceramics may be used so long as they function suitably as a counterweight to the lens and bridge assembly. Moreover, more than one temple weight can be used to achieve the desired effect. While the temple weights are shown in the figure as being substantially spherical, the weight (i.e., counterweight) may be of any shape and may be ornamental if desired (e.g. provided in various shapes and forms such as is common with charm bracelets). Temple weights may also comprise electronic assemblies as well as batteries.

The enlarged area of the of FIG. 2A shows closer detail of the lens and shows the hole 24 and the near (lens or frame) end of the flexible temple element 22 having been enlarged 25 to prevent it pulling through the hole. Enlargement of the near end 25 can be accomplished by any suitable means depending on the material used for the flexible temple element. For example, if the flexible temple element is a polymer, it can be melted to form a ball such as is shown. Alternatively and by way of example, a metal ball could be soldered to the end of a metal flexible temple element or an adhesive may be used when the flexible temple element is comprised of string, woven fiber, cloth, polymer (i.e., plastic) or metal. Knots may be tied in these materials as well for the purpose of keeping the flexible temple from separating from the eyewear due to the force of the temple weight. The flexible temple material may also be fused in a suitable manner (e.g. melted, ultrasonically welded, etc.) to the lens or frame if the materials may be compatibly so joined.

In FIG. 2B the lens 21 again has a flexible temple 22 pulled through a hole having a countersink 26 (shown in detail in enlarged area). Again, the end of the flexible temple element distal from the lens has a temple weight element 23 attached to help shape and hold secure the flexible temple around the saddle of the user's ear. An enlarged area of the lens shows the hole which has a countersink 26. The near end of the flexible temple element 25 is enlarged to prevent pull through and the countersink minimizes the prominence of the enlarged end of the flexible temple at the lens surface. Again, treatment of the near end of the flexible eye ware temple element 25 can be accomplished by any suitable means depending on the material used for the flexible temple element as described for FIG. 2A. It is also possible to glue the end of the flexible element into the countersink area or with proper material, melt or fuse it flush with the surface to facilitate cleaning of the lens surface (not shown in this view). While a countersink has been described, it is obvious that a counter bore could also be employed. The distal end is again is provided with a temple weight 23 for purposes previously described.

In FIG. 2C the lens 21 again has a flexible temple element 22 pulled through a counter sunk hole 26 (shown in detail in enlarged area). Again, at the end of the flexible temple distal from the lens, a temple weight element 23 is attached to help shape and hold secure the flexible temple around the saddle of the user's ear. As previously stated, the temple weight may be ornamental if desired. An enlarged area of the lens shows the hole 26 which has a countersink. The near (lens or frame) end of the flexible temple element 22 is shaped and enlarged 27 to approximate the shape of the countersunk hole 26 to prevent pull through. The countersunk hole 26 allows the enlarged end 27 to become substantially flush with the surface of the lens and glued into place if desired. Flushness with the surface is of value as it facilitates cleaning of the lens surface.

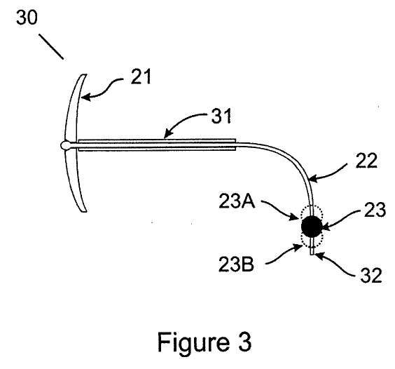

In FIG. 3 is shown an embodiment of an eyewear assembly in cross section 30 wherein the lens 21 has a flexible temple element 22 pulled through a hole in the lens 21. At the end of the flexible temple element distal from the lens 21 is a counterweight element 23 which is attached to help shape and hold secure the flexible temple around the saddle of the user's ear. The counterweight 23 is made adjustable in terms of position along the flexible temple 22 shown as phantoms 23A and 23 B so that it can be positioned at a point of greatest comfort or most desirable to the user. The result may be the creation of a “tail” of material at the distal end 32. This may be removed if desired. The counterweight 23 can be positioned and permanently fixed using any suitable means such as gluing or crimping. Alternatively, the counterweight can be created with an interference fit to make it possible to adjust.

To prevent possible sagging of a flexible temple element 22 of heavier constructions, a housing 31 can be provided. The flexible temple element 22 can be affixed permanently to the housing 31 or the housing 31 can be allowed to move freely over the flexible temple element 22. Moreover, the housing can contain components for visual utilities taking advantage of flexible temple optical materials for transmitting controlled or otherwise modulated light signals from the housing to the eyewear frame outwardly from or inwardly toward the lens for local display.

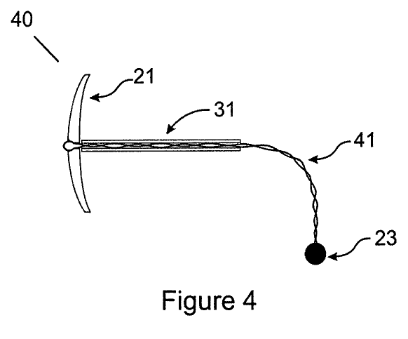

In FIG. 4 is shown an embodiment in cross section 40 wherein the flexible temple element 41 is a woven material or linked chain which is attached to the lens 21 using a suitable method such as one previously described. Materials used in the fabrication of the woven or linked chain can be of metal, fiber, cloth or polymer. The embodiment is shown with an optional housing 31 and a counterweight 23 is attached to the distal end of the flexible temple element 41.

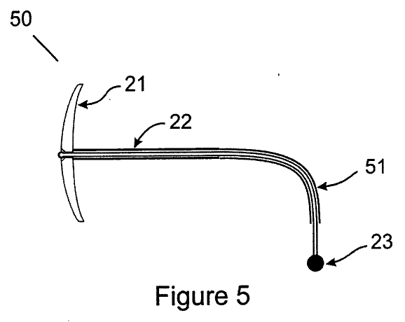

FIG. 5 shows a cross section view of an embodiment of an assembly 50 wherein the lens 21 has a flexible temple element 22 extending through the lens and also through a curved housing 51. The curved housing 51, also flexible, is designed to rest on the saddle of the user's ear. A counterweight 23 is applied to the distal end of the flexible temple element to provide the force needed to secure the eyewear to the user's face. The curved flexible housing can be used for many purposes and in many applications. For example an insulator or protecting mechanism for clear monofilament polymer, flexible fiber, plastic, composite, wire, optical fiber, electrical conductor. The flexible housing or sheath can contain a cable, multi-clad cable, coaxial cable, tubing, rotary flex drive cable or a push-spring cable. Each of these can find many applications. For example the tubing can provide a fluid channel wherein a pressurized fluid reservoir counterweight can be forced through the tube channel and expressed at the toy eyewear, optical fiber can channel light on reading or other matter of interest, keeping the weight of light source, power source and controls down below the neck, channeling only the necessary light to the necessary destination. Rotary flex drive cable can be coupled to gears at the eyewear to spin wheels, propellers, gears or other toy accoutrements, and powered manually or by power source at the counterweight. A push-spring cable with the push-spring controls at the counterweight can allow the eyewearer to manipulate a gripper or extending-contracting objects from the eyewear frame. Thus flexible temple elements comprised of flexible sheaths or housing, can have various inside flexible material which can act as transmission channels for physical manipulation of objects, transmission of rotary power for wheels gears or lens wipers at the eyewear ends controlled from the counterweight or distal end, expression of fluids, transmission of light or power, conduction of power or heat, all from a level blow the ears. The proximity of the eye parallel emitter source on the eyewear design provides mechanisms for using the flexible temple conduits for expression of fluids, projection of pneumatically propelled objects, emission of light for reading or pointing, etc to be focused or targeted by merely pointing the eyes and triggering the action without the necessity of bringing the hands up to the eye level to warn an observer and or the convenience to manipulate or control from below chest level. Expensive eye-following targeting electronics can be simulated relatively inexpensively using eyewear designed with flexible temple construction.

A host of other flexible temple and counterweight applications reside in the optics arena, whereby optical fiber material is used for photonic transmission and optical manipulation and modulation of light signals digitally. These are known to those skilled in the art, and embodiments of the invention provide mechanisms to transport light signals and light object to eyewear using the flexible temple and counterweight structures and components conveniently from below a users ear level.

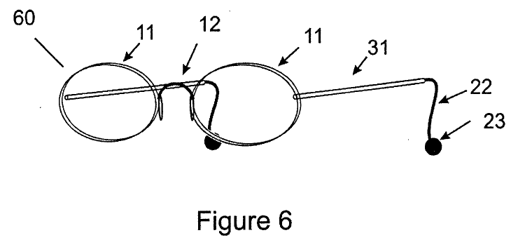

FIG. 6 shows a perspective view of an embodiment of an eyewear assembly 60 which is representative of the general embodiments shown in FIG. 3 and FIG. 4 for added clarity and understanding. In the figure the lenses 11 are attached to a central nose bridge 12 and the housings 31 are moveable or fixed over the flexible temple elements 22 and having counterweights 23 attached as needed.

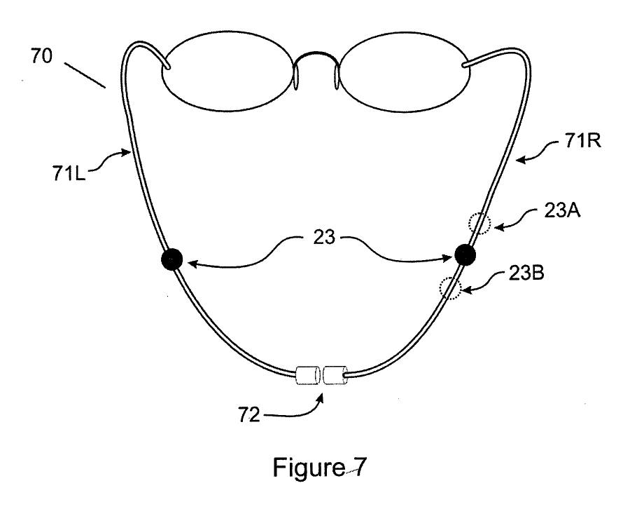

FIG. 7 provides a user's perspective view of another embodiment of an eyewear assembly 70 where the left and right flexible temple elements 71L and 71R are of extended length and disposed to join together at a point of connection 72 behind the user's head. The connection of the two halves can be accomplished using any suitable means disposed to easy an rapid disconnection in any direction at forces below that which can potentially cause injury to the user. Examples include a low force interference fit ball and socket or a magnetic connection but it is not so limited.

Counterweights 23 are provided along the length of the flexible temples 71L, 71R and can adjustable (as represented by the phantom counterweights 23A and 23B) to the comfort of the user. Once properly positioned, the can be affixed permanently to the chose location if desired.

As with all structures shown, it should be evident that the counterweights 23 can be affixed to the flexible temple elements 71L, 71R at any time and need not be provided directly with the assembly to the user. For example, one could affix the counterweights 23 by crimping them to the flexible temple elements 71L, 71R in the same manner as a fishing weight is attached to a fishing line.

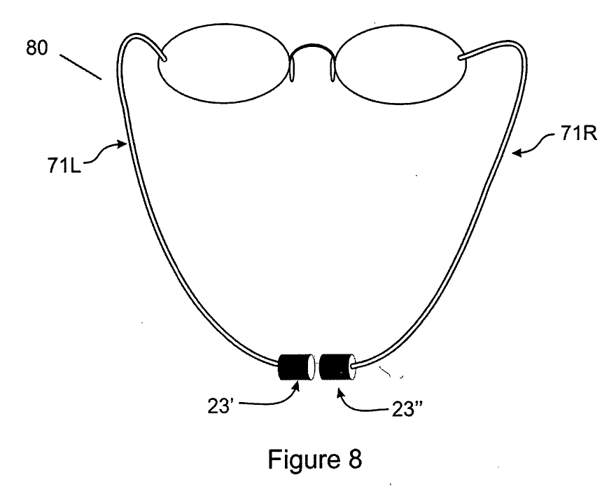

FIG. 8 provides a user's perspective view of another embodiment of an eyewear assembly 80 where the left and right flexible temple elements 71L and 71R are of extended length and disposed to join at least one counterweight (23′ or 23″). Said counterweight (23′ or 23″) is also a connecting element disposed to connect together with another joining feature (23′ or 23″) at a point of connection behind or in front of the user's head that is desirably an approximate midpoint behind or in front of the user's head when in use. Again the connection of the two halves can be accomplished using any suitable means disposed to easy an rapid disconnection in any direction at forces below that which can potentially cause injury to the user. Examples include a low force interference fit ball and socket or a magnetic connection but it is not so limited.

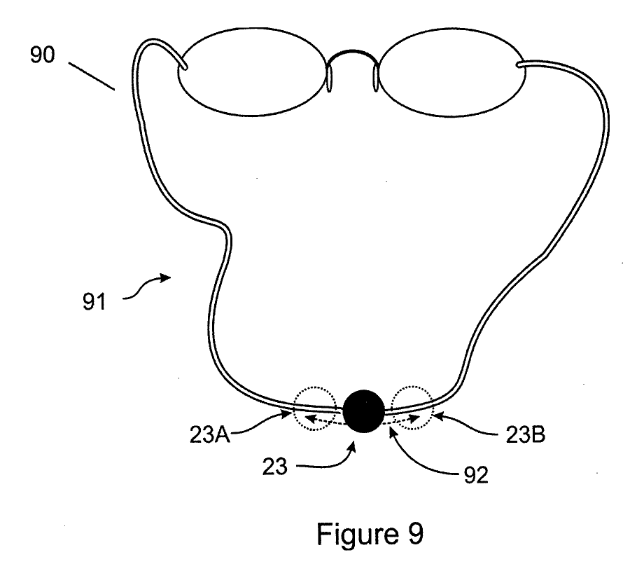

FIG. 9 provides a user's perspective view of another embodiment of an eyewear assembly 90 where the flexible temple element for both sides of the head is comprised of a unitary element 91 disposed with at least one sliding counterweight 23. The counterweight 23 is disposed to slide freely along the length of the unitary flexible temple element (as represented by counterweight phantoms 23A and 23B) along the double arrow arc line 92 provided to indicate movement. The counterweight 23 will desirably come to rest such that that the forces on the left and right sided of the glasses are approximately balanced. While the figure shows only a single moveable counterweight element, it is obvious that a plurality of counterweight elements could be employed to accomplish the objective. This statement is relevant for all embodiments described herein.

If desired for safety, a quick disconnect or frangible feature can be provided along the length of the flexible temple element to assure separation at a pressure less than would cause harm to the user.

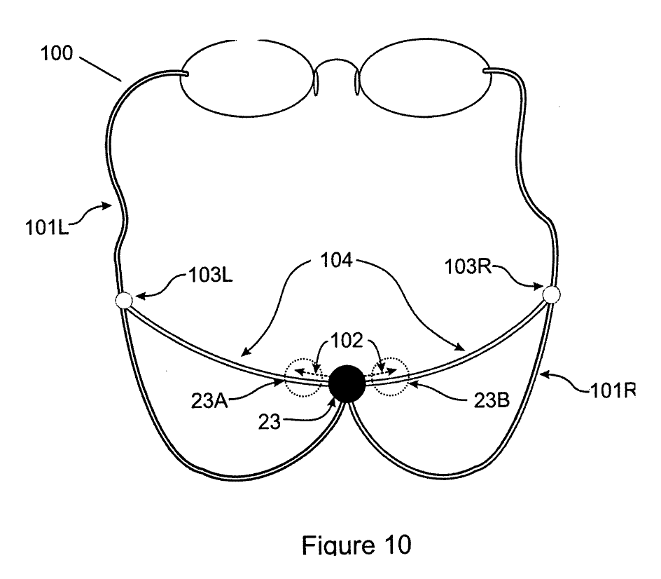

FIG. 10 provides a user's perspective view of another embodiment of an eyewear assembly 100 where the flexible temple element for both sides of the head is comprised of left and right flexible temple elements 101L and 101R respectively each affixed to a counterweight 23. The counterweight is disposed to slide freely (as represented by counterweight phantoms 23A and 23B and the double arrow arc line 102 provided to indicate movement) along the length of another flexible element 104. Flexible element 104 is secured to the left and right flexible temple elements at predetermined locations 103L and 103R. The counterweight 23 will desirably come to rest such that that the forces on the left and right sided of the glasses are approximately balanced.

It is to be understood that the invention is not limited to the illustrations described and shown herein. The illustrations provided are deemed to be purely illustrative of the best modes of carrying out the invention, and which are susceptible of modification in terms of form, size, and the arrangement of certain parts and details of operation. The invention rather is therefore intended to encompass all such modifications which are within the spirit and scope as defined by the claims.

What is claimed:

1) A flexible temple assembly for eyewear comprising:
one end of at least one flexible temple element coupled to the eyewear;
at least one counterweight, coupled to the flexible temple element's distal end, disposed to maintain tension on the flexible element;
whereby the tension on the flexible temple element is sufficient to stably maintain the eyewear on the wearer's face.

2) The flexible temple assembly of claim 1 wherein the flexible temple element material is chosen from a group consisting of clear monofilament polymer, chain, cloth, woven string, flexible fiber, plastic, composite, wire, optical fiber, electrical conductor, cable, multi-clad cable, coaxial cable, metal, tubing, rotary flex drive cable or a push-spring cable.

3) The flexible temple assembly of claim 1 wherein the flexible temple element comprises optical fiber material for photonic transmission.

4) The flexible temple assembly of claim 1 wherein the flexible temple element comprises doped optical material for modulating the material index of refraction.

5) The flexible temple assembly of claim 1 wherein the position of the counterweight is adjustable.

6) The flexible temple assembly of claim 1 wherein the size, shape and weight of the counterweight is selectable.

7) The flexible temple assembly of claim 1 wherein the shape and color of the counterweight serves an ornamental purpose.

8) The flexible temple assembly of claim 1 wherein the counterweight contains a power source.

9) The flexible temple assembly of claim 1 wherein the counterweight comprises an electronic or electrical assembly.

10) The flexible temple assembly of claim 1 wherein the counterweight comprises an electro-mechanical assembly containing electronic, mechanical and optical components.

11) The flexible temple assembly of claim 1 wherein the counterweight is physically protected from the lenses of the eyewear when not in use.

12) The flexible temple assembly of claim 1 wherein the flexible temple assembly is detachable from the eyewear.

13) The flexible temple assembly of claim 1 wherein the counterweight is detachable from the flexible temple element.

14) The flexible temple assembly of claim 1 wherein a side one and a side two flexible temple element merge to form a single flexible temple element extending beyond the ear load bearing points such that at least one self positioning counterweight maintains tension to the flexible temple element.

15) The flexible temple assembly of claim 1 wherein the distal ends of a side one and a side two flexible temple element extend beyond the ear load bearing points and further comprising at least one additional connecting segment connecting the side one and side two flexible temple elements supporting a self positioning counterweight which adjusts the tension to the flexible temple element.

16) The flexible temple assembly of claim 15 further comprising a shared distal end counterweight connecting the side one and side two flexible temple elements at the connecting segment.

17) The flexible temple assembly of claim 1 further comprising a housing component that contains the flexible temple element and is conformal to and disposed on the saddle of the ear, secured by the tension in the flexible temple element.

18) The flexible temple assembly of claim 2 wherein the tubing is coupled with fluidic pressure source counterweights for ejecting or pneumatically expelling fluid out from eyewear, targeting expulsion by the eyes and controlling expulsion from counterweight components.

19) The flexible temple assembly of claim 2 wherein the rotary flex drive cable transmits rotational power along the temple longitudinal axis from the counterweight components to the eyewear, providing a mechanism for manipulating objects coupled to the eyewear.

20) The flexible temple assembly of claim 2 wherein temple optical fiber channels monochromatic or polychromatic light from the counterweight power sources to the eyewear.

21) The flexible temple assembly of claim 2 wherein the push-spring cable provides a mechanism to manipulate objects coupled to the eyewear from the counterweight.

22) An eyewear assembly comprising:
at least one flexible temple element attached to eyewear at one end and extending over a wearer's ear to a counterweight proximal to the distal end of the flexible temple element.

23) The eyewear assembly of claim 22 further comprising a mechanism coupling flexible temple element side one and side two distal ends.

24) The eyewear assembly of claim 22 wherein the coupling mechanism is chosen from a group consisting of weights, magnets, ball and socket, wire, metal, plastic, glass, and polymer elements.

25) The eyewear assembly of claim 22 wherein the coupling mechanism is disposed to release at design stresses below those determined to cause wearer injury.

26) The eyewear assembly of claim 22 wherein the eyewear is chosen from a group consisting of a framed lens assembly, rimless lens assembly, a monolithic structure having two lenses and a single lens.
